(19) United States
(12) Patent Application Publication
(10) Pub. No.: US 2005/0289027 A1
(43) Pub. Date: Dec. 29, 2005

(54) Peer-to-peer database connector for tax and other information

(76) Inventor: Michael Carlos Buarque De Macedo, Bethesda, MD (US)

Correspondence Address: MICHAEL C. BUARQUE DE MACEDO, 7001 LOCH LOMOND DRIVE, BETHESDA, MD, 20817, US

(21) Appl. No.: 10/856,759

(22) Filed: Jun. 1, 2004

(51) Int. Cl. G06F 17/60

(52) U.S. Cl. 705/31

(57) ABSTRACT

A method is provided for the connection of heterogeneous database's of various manufacture and running different operating systems in a peer to peer fashion, where a central web server sends mobile code for a variety of operating systems and said mobile code provides a client software interface (TAXSOFTWARE) to input and edit tax return or other information; said mobile code provides database server software (TAXDBC) interface means to allow one or more said client mobile code to connect to one or more databases at various locations on the network, intranet or internet to save information and the schema may be updated on demand by inspecting the SQL; said users may run either the client mobile code (TAXSOFTWARE) or server mobile code (TAXDBC) or both on each computer.

### CROSS-REFERENCE TO RELATED APPLICATIONS

Not applicable

### STATEMENT REGARDING FEDERALLY SPONSORED RESEARCH OF DEVELOPMENT

Not applicable

### REFERENCES TO SEQUENCE LISTING, A TABLE OR A COMPUTER PROGRAM LISTING COMPACT DISK

Not applicable

### BACKGROUND OF THE INVENTION

The present invention relates to database sharing across a computer network such as the internet in a peer-to-peer relationship.

### DESCRIPTION OF THE PRIOR ART

The Following patents are prior art:

Patent application No. 20040002906, a “Tax transaction system” did not provide for storing the tax information in peer-to-peer connected databases.

Patent application No. 20040044776, a “Peer to peer file sharing system using common protocols” is for the sharing of files in a peer-to-peer method but does not provide for connecting databases and sharing data in databases in a peer-to-peer method.

Patent application No. 20040088646, a “Collaborative content coherence using mobile agents in peer-to-peer networks” is for using mobile agents to keep files updated in a peer-to-peer network. But this does not provide a method to connect databases or keep database up to date in a peer-to-peer network.

Patent application No. 20040039781 “Peer-to-peer content sharing method and system” provides a method to share content is a peer-to-peer method. But, it does not provide a method for the users to directly log on to databases in a peer-to-peer method. In this patent all of the users log on to a central server before sharing content in a peer-to-peer method.

Patent application No. 20030061218 “Method and system for utilizing a database as a service” provides a method for connecting a database to the internet with a UI. But it does not provide a method to connect those databases to the users is a peer-to-peer method.

Patent application No. 20040064456 “Methods for data warehousing based on heterogenous databases” provides for integrating the schema of said plurality of source databases into a global schema, including resolving semantic conflicts between said source databases. But, this patent does not provide for adjusting the schema of the databases on demand as data is stored in a database.

Client/server networking, in a strict sense, means that one system provides a service of some sort and another system, or perhaps multiple systems, consumes the service. The service provided could be file storage, database queries, authentication services, or any number of other services. Traditional client/server systems initially filled the need of housing and managing large amounts of data centrally. Instead of each user housing and managing its own data, the data and access controls on the data were stored on a central server where administrators could monitor a single system and ensure that service was not interrupted. This was the norm for many years until users began setting up their own networks at home and small office networks at work. It became desirable at that point for data sharing between these users without the need for a large server and a large administrative team.

Peer-to-peer networking is an alternative to client/server networking. Peer to peer networking implies that all participants are “equal”. In other words, no single entity has to act as a “server” and provide service to the other users of the network. Instead, all users of the system act as mini-servers, providing service (usually sharing data and other files) but not having to maintain the overhead of server management in the traditional sense, as described above. In addition, the participants of a peer-to-peer system also act as clients, consumers of service, of other systems in the network. In a sense, in a peer-to-peer environment, everyone is both a client and a server, although not necessarily a server all the time, e.g., consider a case where there is no data to be “served”, and not necessarily a client all the time, e.g., when a particular user is only “serving” data and not consuming services from other peers.

In its most simple form, a flat-file database is nothing more than a single, large table (e.g., a spreadsheet). A flat file contains only one record structure; there are no links between separate records. Access to data is done in a sequential manner; random access is not supported. Access times are slow because the entire file must be scanned to locate the desired data. Access times can be improved if the data is sorted but this introduces the potential for error (e.g., one or more records may be misfiled). Other problems with a flat-file database include 1) data redundancy; 2) data maintenance; and 3) data integrity. Flat file data structures are only viable for small data processing requirements.

JDBC is an industry standard database connection for use with Java or Microsoft .NET J#. It allows Java or J# programs to connect to a database.

ODBC is an industry standard database connection for use with Microsoft Windows. This allows programs that are running on Microsoft Windows to connect to various industry-standard databases.

A schema is the structure of a database system, described in a formal language supported by the database management system (DBMS). In a relational database, the schema defines the tables, the fields in each table, and the relationships between fields and tables.

SQL is Structured Query Language—SQL is a standard interactive and programming language for getting information from and updating a database. Although SQL is both an ANSI and an ISO standard, many database products support SQL with proprietary extensions and/or different syntax and/or different limitations to the standard language.

Mobile code is code that can travel over the internet, intranet or other network from one computer to another and execute. An example of this is java applets, Microsoft NET J# Browser controls, Microsoft Active-X controls and/or Microsoft .NET WinForms. This allows more of the processing power of greater number of computers to solve problems faster. This is particularly important during peak load periods when many users are using the website at the same time. Also, this allows for a richer user interface with more advanced features and error notification.

Taxpayers are required to fill in complex tax forms and pay taxes to national and state taxing agencies such as the United States Internal Revenue Service (IRS). The tax forms can be very complex from 1 page to 250,000 pages when printed out. Software has been developed to allow users to complete these tax returns by many companies.

Various tax web sites allow users to prepare, e-file and pay taxes. The current architecture for the tax web sites in the market is to store the users tax information is a large central database (See FIG. 1) that all users of the tax web site share. The large central database must be maintained and available to potentially millions of users who may all need access to information at the same time. Also, the data must be maintained for a long time since the users may require access to their data years later. There are many disadvantages to a single large central database:

(a) Reliability. If the central database fails or loses data all users are effected.

(b) Scalability. As the number the number of users increases more and larger computer equipment is required to host the large central database.

(c) Performance. As more users connect to the web site the performance of a large central database decreases. Normally, all users of tax web sites want to connect to the central database exactly at the same time when the taxes are due.

(d) Cost. Preparing for this peak load is very expensive. The maintenance of the central database can be very expensive.

(f) Security. If the large central database is compromised all of the users' personal tax information is compromised.

Normally, only a small number of users, such as taxpayers and their financial advisors and accountants, actually require access to a given tax return, herein after referred to as a peer-group. The current systems provided by tax web sites allow the users to create a username and password to get access to their tax information.

Many technologies have been developed to allow larger and larger centralized databases to be created to store larger amounts of data.

I have already started to solve some of these problems for the current web site I have designed for Taxsoftware.com. The Taxsoftware.com web site does not use a central database to store data for each user. Each user stores the data for tax returns in flat files on each user's individual computer. Each user of the web site may be running different operating systems so the tax software has to be written in managed mobile code such as Java Applets or Microsoft .NET J# Browser Controls. As each user connects to the web site the user gets the latest version of the Java Applets or J# Browser Controls Applets. The central web server only provides applets to each user if the code has changed since the last user visit. All of the applets are signed and versioned using industry standard code signing certificates to insure the code is safe and has not been tampered with in transit over the Internet to the user's computer. This also insures that each user receives the same current version of the software.

This is better than the single large databasing because it offers:

Scalability. As more users are using the web site there is no load on the central server database.

Performance. Users only get new code when the mobile tax code changes.

Security. Since the data is stored on each individual computer, no other user can access a different user's data.

There are many disadvantages to using flat files to store the tax and accounting information:

Reliability. If the user's data files are lost or damaged due to a computer crash, then user has no way to recover the data.

Concurrency. If multiple users want to edit the same tax return file at the same time, the flat files do not allow for concurrent editing.

Multiple Computers. If the user has multiple computers the user must copy the files to each computer to view or edit the tax returns. This can create multiple versions of the same tax return and there is no way to resolve the conflicts.

The object of the present invention is to allow small peer-groups of users to share tax, accounting and other information using peer-to-peer databases without a large central database using mobile code.

A further object is to support a wide variety of operating systems with the mobile code such as JAVA, and Microsoft .NET.

A further object of the invention is to allow the movement of data between heterogeneous databases from different vendors.

A further object of the invention is to allow automatic creation and/or modification of a schema to hold the data in the peer-to-peer databases on demand.

A further object of the invention is to allow users to view and/or edit prior versions of the tax returns.

A further object of the invention is to allow users to store images and other types of data with the tax return information.

A further object of the invention is to develop a method to identify where the data in the tax return is to be stored in the database.

A further object of the invention is for the mobile code to handle SQL translations when the database does not support the number of columns being sent to it.

A further object of the invention is to support a wide variety of connections to the database.

A further object of the invention is to support connecting to a database using only protocols that most firewalls permit.

### SUMMARY OF THE INVENTION

This summary of the invention section is intended to introduce the reader to aspects of the invention and is not a complete description of the invention. Particular aspects of the invention are pointed out in other sections herein below and the invention is set forth in the appended claims, which alone demarcate its scope.

This invention of a peer-to-peer database connection using mobile code can be used with many different types of applications such as tax software, accounting, inventory control, customer relationship management and other software. We will be using tax software to demonstrate the application of this invention.

In FIG. 2 a preferred embodiment of the invention is shown. Each user (203, 204, 205, 209, 212, and 213) connects to the web server with a browser. Since each user may be using a different operating system the web server (201) must provide the correct mobile code to each user. The mobile code is transferred via one or more firewalls (206). Some users may not have access to a database (213) so then the user only downloads the mobile code client code prepare tax returns and stores the data in flat files. Other users (203) may have a single database (202) for personal user. In this case the user downloads the mobile client code to prepare tax returns and the mobile server code to access the local database (202). Some users (204, 205 and 209) may form peer-groups and share a single local database (207). Each user can download the mobile client code to prepare tax returns and the mobile code to access the shared local database (207). Each user can connect directly to the database (207) via a JDBC or ODBC connection. Or a user (204) can connect through one or more firewalls such as a local firewall (208) to a remote firewall (210) where a remote user (212) is acting as a peer server to share the remote database (211).

Single users can connect to the TAXDBC peer-to-peer connection. In this case only one database is used by the single user. This is better then a single large central database because:

(a) Security. Since the user's data is in his local database, no one else can access his data. If the central web site is compromised the user's is not compromised.

(b) Performance. The user can access the data in his local database much faster then the time it takes to access data in the large central database. During times of peak load there is no additional load on the central database since there is no central database.

(c) Maintenance. The user can maintain and backup his local database as per the user's own requirements.

(d) Low Cost. The cost of providing a large central database that can handle large peak loads is eliminated since there is no large central database.

It is also better than flat files because:

(a) Reliability. The user can use an industry standard local database for backup and recovery.

(b) Multiple computers. The user can access his data from multiple computers. With flat files the user would have to manually copy his data to use multiple computers.

(c) Data integrity. The local database can provide data integrity so that if a transaction does not complete the data in the database is still valid.

Multiple users can form peer-groups to share data. For example, an accounting firm where there are several tax preparers can form a peer-group. Each peer-group of users can have a local database for all of the tax returns prepared by the peer-group.

This is better than a large central database because:

(a) Security. Since the peer-group's data is in a shared local database, no one else can access the peer-group's data. If the central web site is compromised the peer group's is not compromised. The peer-group can install their own firewall and other security systems to protect the local database.

(b) Performance. The peer-group users can access the data in their local database faster than it take to access data in a large central database. During times of peak load there is no additional load on the central database since there is no central database.

(c) Low Cost. The cost of providing a large central database that can handle large peak loads is eliminated since there is no large central database.

(d) Maintenance. The user can maintain and backup the local database on peer-groups own schedule and needs. The peer-group is not dependent on the central database administrator's schedule.

It is also better flat files because:

(a) Reliability. The user can use an industry standard local database for backup and recovery.

(b) Multiple computers. Each user can access his data from multiple computers. With flat files the user would have to manually copy his data to use multiple computers.

(c) Concurrency. Multiple users can access the data at the same time. The industry standard database is designed to handle concurrent users.

(d) Data integrity. The local database can provide data integrity so that if a transaction does not complete the data in the database is still valid.

Sometimes an outside auditor, accountant or other person may need access to a tax return in the local database. These transient users can be given access to the group database for a short period of time using the TAXPOOL connection described below.

### BRIEF DESCRIPTION OF THE DRAWINGS

FIG. 1 is a drawing of the prior art of using a single large database and web server for all users of the tax return preparation web site using client computers.

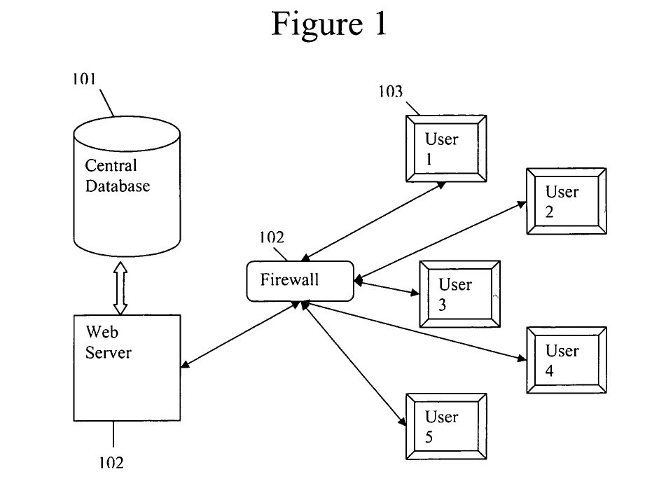

FIG. 2 is a drawing of an embodiment of the invention where the data is stored in a series of databases and the client computer prepare the tax return by storing the data and connecting to the databases in a pear-to-pear fashion.

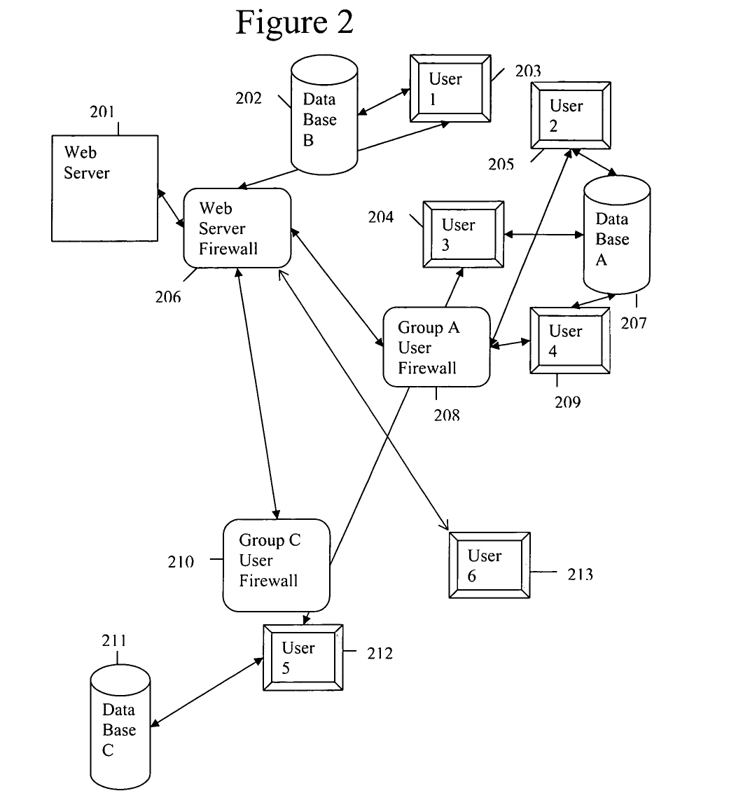

FIG. 3 is a drawing of the web browser on the client computers connecting to the web server and down loading the mobile code for execution on each client computer.

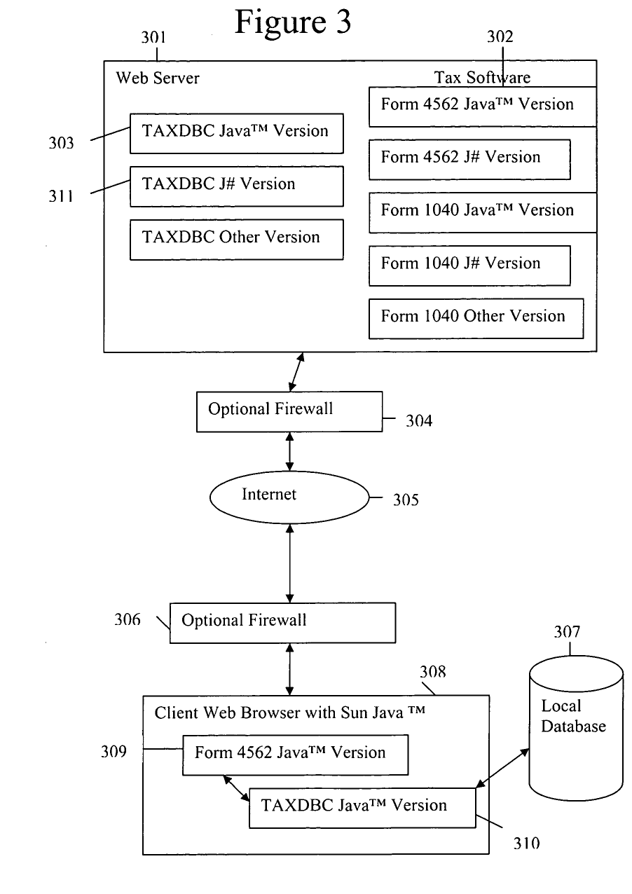

FIG. 4 is a drawing of the TAXDBC creating a schema in a local database on demand.

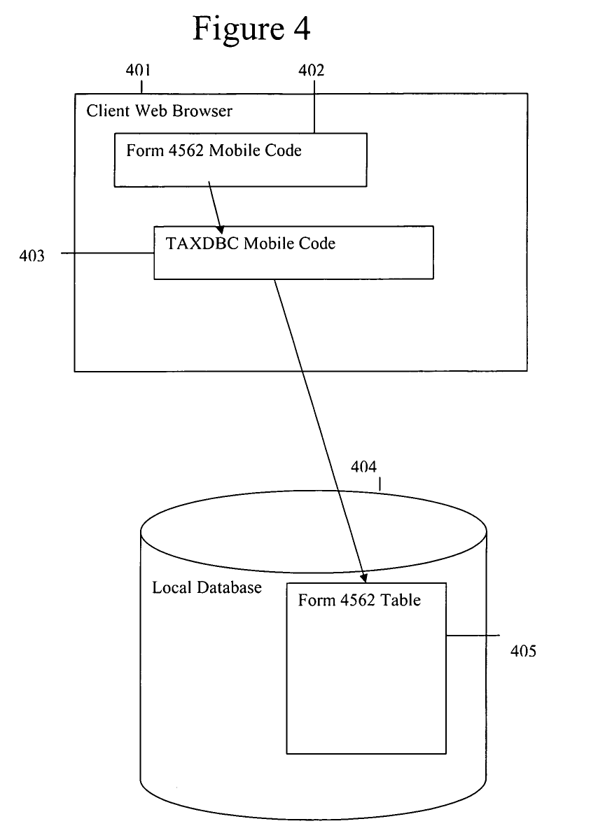

FIG. 5 is a drawing of the TAXDBC handling SQL syntax translation for the local database.

FIG. 6 is a drawing of the TAXDBC updating a schema in a local database.

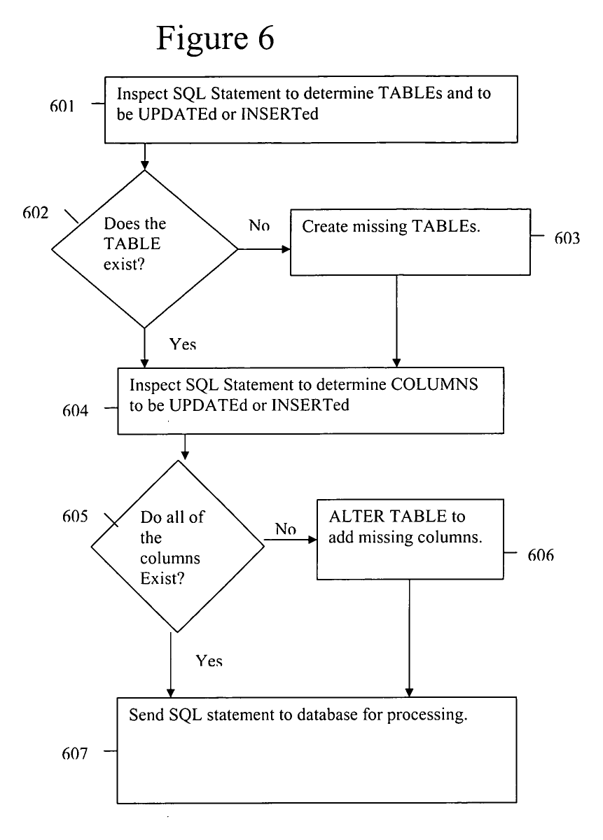

FIG. 7 is a drawing of the TAXDBC database connector tracking different versions of a tax return.

FIG. 8 is a drawing of the TAXDBC database connector storing images and other data into the database.

FIG. 9 is a drawing of the TAXDBC database connector updating and locating a row in a database.

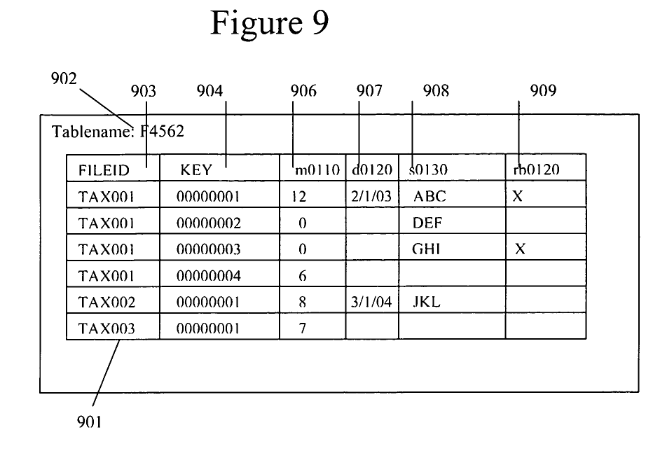

FIG. 10 is a drawing of the TAXDBC simulating a single table row when the local database can not support a row with the number of columns required.

FIG. 11 is a drawing of the TAXDBC connecting to the local database via HTTP protocol due to firewall restrictions on JDBC or ODBC connections.

### DETAILED DESCRIPTION OF THE INVENTION

Each user of the web site (203, 209, or 212) may be running different operating systems so the TAXDBC (303 and 311) and the tax and accounting software (302) has to be written in managed mobile code such as Java Applets (303) or Microsoft .NET J# Browser Controls (311), C++, Microsoft WinForms, Active-X Controls or other computer language. As each user (308) connects to the web site the user gets the latest version of the Java Applets or J# Browser Controls Applets. The central web server needs to provide the correct mobile code (309 and 310) to each user based on the operating system the user has. The central web server only provides applets to each user if the code has changed since the last user visit. All of the applets are signed and versioned using industry standard code signing certificates to insure the code is safe and has not been tampered with in transit over the Internet to the user's computer. This also insures that each the same current version of the software to each user.

There are one or more web servers (201) that all of the users (203, 205, 209, 212 and 213) connect to. But no data is stored on the central web server (201). There is no central database. Each user stores their data in their local database (202, 207 or 211) or in flat files (213). The advantage of supporting users with flat files is so that small users (213) can still prepare tax returns without the burden and cost of setting up a database. Groups of users (204, 205 and 209) may share the same local database (207). One user (204) may have access to several local databases (207 and 211) with different tax return data in each local database. The user's local database (202) can be anywhere in the Internet, it may not be on the same computer or in the same office as the user. Each local database will authenticate users as per the local database's own method including username and password, Digital certificates, IP restrictions or other type of authentication. Users of the central web site can not access another local database unless authorized by each local database the user wants to connect to.

Since each user may have a different database (311) on the local computer the TAXDBC (310) must be configurable to support as appropriate a JDBC or ODBC connection to the user's local database. The local database can be accessed simultaneously by all of the users in the local intranet or via a VPN connection. The local database will not be available to the other users of the tax web site. Each user or group of users of the tax web may have their own local database for storing tax, accounting or other information. The mobile code may have a settings web page that allows the user to enter the local configuration information such as:

ODBC Data Connection and ODBC Database Connection Name. When this information is entered the TAXDBC will use the industry standard ODBC connection to connect to the local database or a JDBC to ODBC connector to connect to the local database.

JDBC Database Connection. When this is selected the user may optional specify a JDBC Driver for the TAXDBC to initialized. Also the user must supply a JDBC URL of the location of the local database. The local database URL can be anywhere in the local intranet of the user or the same computer. Also, the TAXDBC can make a secure connection via Oracle™ SQLNET™ or other JDBC compatible connection.

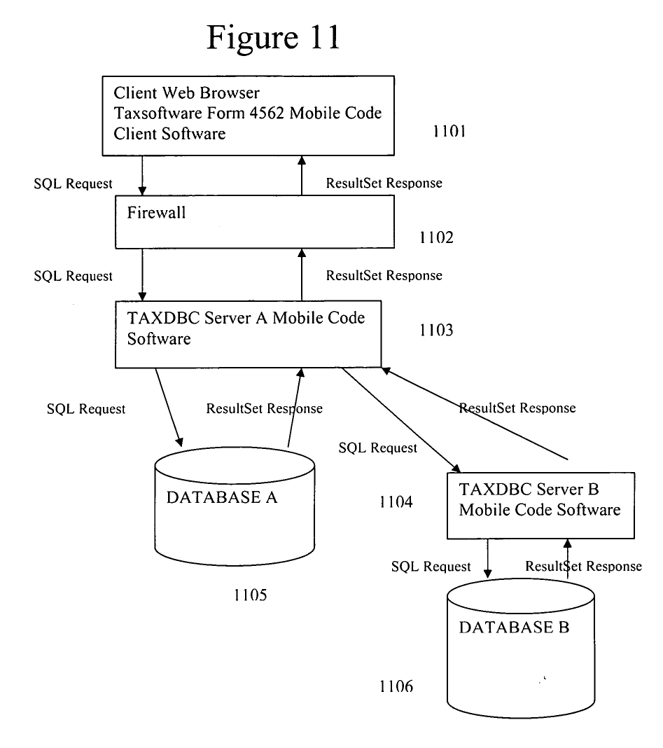

Sometimes an ODBC or JDBC connection is not possible due to the firewall blocking such connections or the local intranet security policies. When, that happens a TAXDBC user can provide a TAXPOOL connection (FIG. 11) to the local database. The Taxsoftware Client Software (1101) sends one or more SQL Requests. The TAXPOOL connection is a standard HTTP Connection that is not blocked by most firewalls (1102). The TAXPOOL connector provides a customized HTTP Connection using any standard TCP/IP connection. The TAXDBC becomes a HTTP web server (1103 and 1104) and will accept connections from other TAXDBC users or other TAXDBC servers to the local database (1105 and 1106). All data is transferred using standard HTTP protocols with the TAXDBC SQL commands in a standard format such as XML or SOAP. The actually XML data in the web pages transferred may be encrypted using standard encryption such as SSL, AES and/or Digital Certificates. Users can be authenticated by each local database. There can be a locator service provided to local TAXPOOL connections for a specific company or the user can enter the IP address or URL and port of the TAXPOOL connection the user wants to connect to.

Before each request is sent the local database the tax software (402) sends a request of the table and columns required to the TAXDBC (403). The TAXDBC creates the table (405) and columns as required by the tax software request in the local database (404).

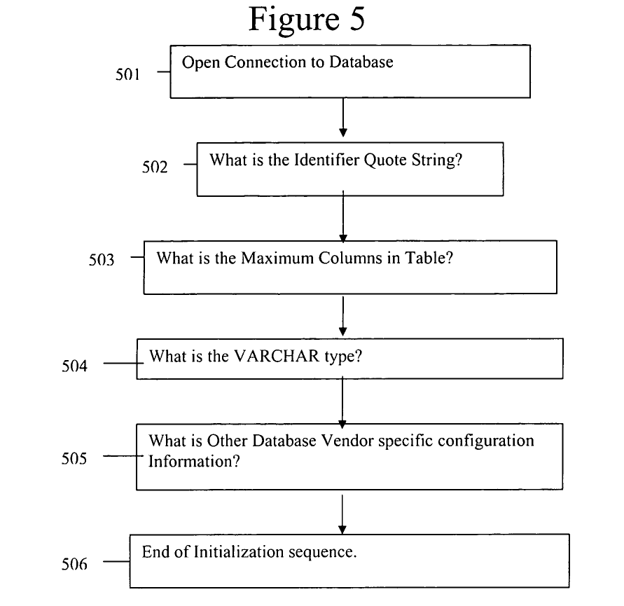

Since each local database may have a different syntax for the SQL commands the TAXDBC must query the local database (FIG. 5) to determine the SQL syntax required for the local database. After a connection is established to the database (501), the TAXDBC must query for the following items of information:

(a) Identifier Quote String (502)—Since each local database may have a different local identifier Quote String such as ′ or ″, the TAXDBC must determine what is required by the local database and change all SQL to use the correct one as appropriate.

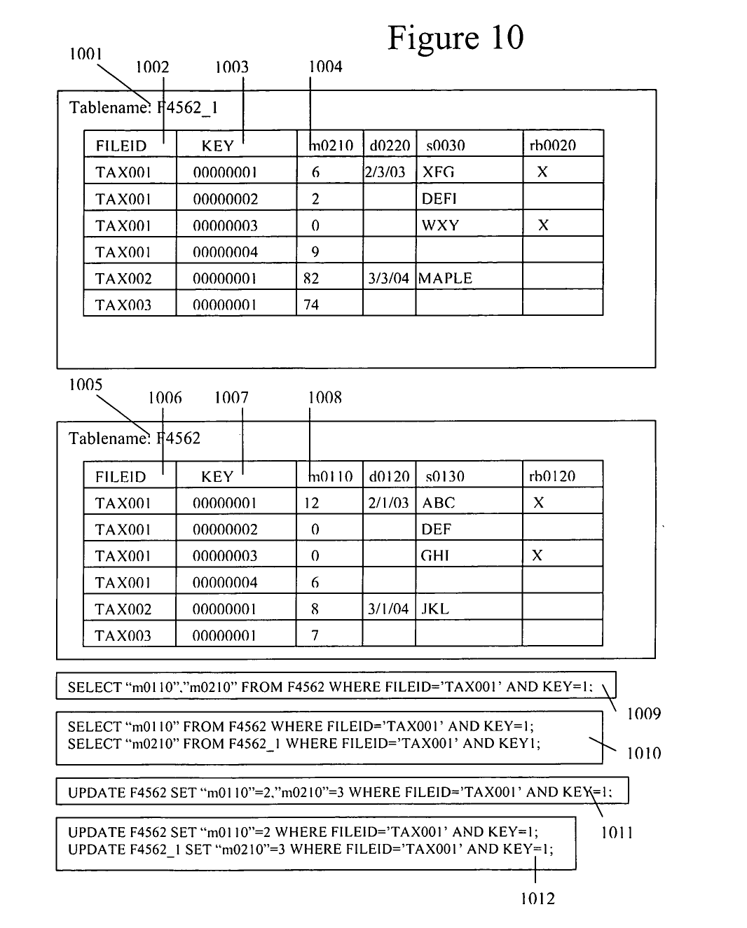

(b) Maximum Columns in Table (503)—If the number of columns required for a given row in a database table exceeds the maximum number of columns in the local database tables, then two or more tables must automatically be created to hold the data as if the data was stored in one larger table (FIG. 10).

(c) VARCHAR type (504)—Since each local database may use a different syntax for the SQL VARCHAR type such as VARCHAR or VARCHAR2 the TAXDBC must determine the correct syntax for the VARCHAR type and change it as the data is accessed.

(d) Other configuration information (505)—Any other configuration information that may be required to format the SQL may be obtained from the local database.

Since there are many databases to be supported and some may have missing or incomplete schemas to hold the data required for a given tax form or program. If the SQL commands being sent the database are INSERT or UPDATE the SQL Statement is inspected (601) before the command is sent to the database. A check of the database schema is done to see if the table exists (602). If the table does not exist the table is created in the database (603). Only the columns required or referenced in SQL statement are created. The SQL statement is then inspected to determine the COLUMNs referenced in the statement (604). The table is inspected in the database to see if all of the columns exist in the database (605). If any columns are missing the TABLE in the database is ALTERed to add the missing columns (606). After the database schema has been updated on demand to insure it can hold the data being sent the database the SQL statement is then sent to the database for processing (607).

If the database has a limitation on the number of columns in a table and the number of columns required by an INSERT or UPDATE statement is more than the maximum allowed then two or more tables must be created (1001 and 1005). Each SQL statement is inspected such as (1009 and 1011). If the table has been separated (1001 and 1005) then the SQL statement needs to be rewritten. The FILEID (1002 and 1006) which represents a tax return and the KEY (1003 and 1007) which represents the occurrence of a form, is used to find corresponding ROWs in the two or more tables. After inspecting the SQL statements the SQL statements are re-written (1010 and 1012) to access each of the separated tables (1001 and 1005) and the columns that are in the respective tables (1004 and 1008).

The data can be sent to the local database as a series of rows. Each tax form can be stored as a single row in the database (901). Each row to be sent to the local database needs to contain a minimum set of information to identify where in the database to put the row:

(a) TABLE NAME (902). The Table name for a tax form could be the name or number of the tax form such as F4562 for the IRS Form 4562.

(b) FILEID (903). The FILEID is a unique identifier for the tax return the form relates to. Each tax return may contain a large number of forms. Each row for a form that relates to that tax return will have the same FILEID. Each version of a tax form will have a unique FILEID.

(c) KEY (904). The KEY is a sequential number to indicate which occurrence of the form the ROWSET represents. So if there are four IRS Form 4562's in a tax return than a KEY 0, 1, 2, and 3 would be assigned to each ROW.

(d) COLUMN DATA (906, 907,908 and 909). Each field of data on the form would have one column that corresponds to the field on the form. The names of the columns can be the official government SEQUENCE numbers or LINE CODES that are used for EFILING tax returns. Then later during the EFILE process it is much easier to line up the data for transmission. Also, each column name can have a column name prefix or other code to indicate the type of data expected to be in the column for later verification such as m for money (906), f for floating point, s for String (907), r for Required strings, d for date (908), rb for Boolean (909), ein for Employer Identification number, and ssn for Social Security Number.

A collection of rows are set to the local database as a ROWSET. The table or tables or columns or rows referenced in the ROWSET may not exist in the local database. So the following UPDATEINSERT procedure must be followed:

(a) If any of the tables referenced in the ROWSET do not exist The TAXDBC must detect this and the table must be created by the TAXDBC connector with all of the columns referenced in the ROWSET (603). The COLUMN name prefix (906, 907, 908, and 909) is used to determine the column types for the table creation.

(b) If the table exists but any columns are missing from the table the TABLE must be altered (606) to add the additional columns required by the ROWSET.

(c) As each ROW is processed a SQL SELECT has to be done to see if the ROW (901) is already present in the table. The table name, KEY (903) and FILEID (904) uniquely identify each ROW (901) in the database. If the row is present the TAXDBC has to send a SQL UPDATE to the database. If the row is not present in the local database a SQL INSERT is done to send the data to the local database.

(d) Any errors during the procedure can be written to a log for later analysis.

All of the tax calculation, accounting and other software need to send the ROWSETs to the TAXDBC connector in a standard format such as an XML format. The TAXDBC connector then sends the data to the local database. If the tax calculation, accounting or other software needs data from the local database the TAXDBC returns the data selected as a ROWSET in the same standard format such as an XML format.

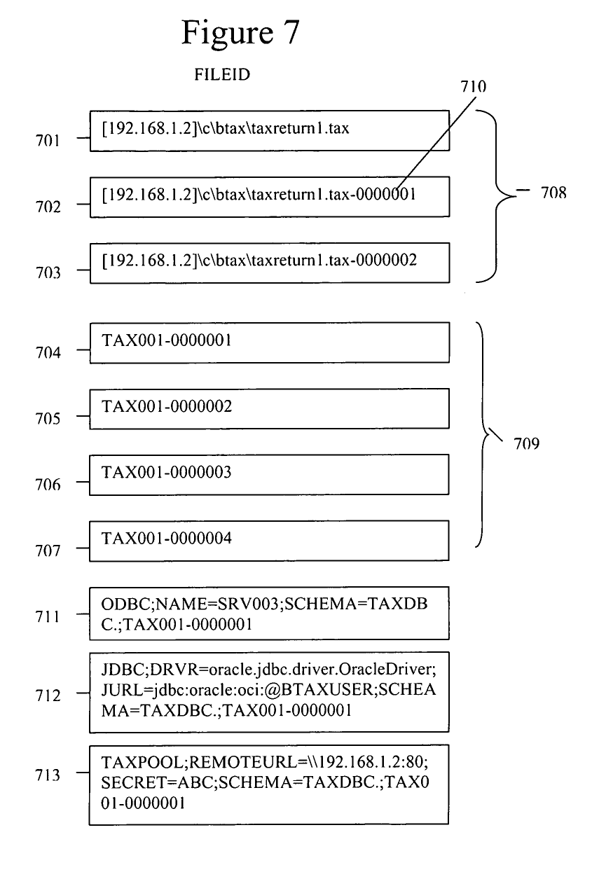

Users may need access to prior versions of a tax return. The FILEID column is added to all of the tables and rows in the database. The FILEID is the same value for all rows that are part of the same tax return. In FIG. 7 we see how FILEIDs can be grouped to have many versions of the same tax return. If the tax return originated outside of the database a FILEID (701) of the path to the original flat file containing the tax return can be used. This allows the original tax return to be located and identified. When the tax return is edited by another user a new FILEID is created (702) based the first FILEID and a version number is appended (710). When the user checks out the file to edit it all of the rows that contain the first FILEID (701) are duplicated to contain the second FILEID (702). Then as the user changes the data in the ROWs on the ROWs containing the new FILEID (702) are UPDATEd and INSERTed. After the user is done with the file and the user checks in the tax return then a new FILEID is assigned for the next CHECKOUT (703). All of the FILEIDs (701, 702 and 703) are associated (708) with different versions of the same tax return. The user can then view or edit or recover the old versions of the tax return if needed.

If the tax return originated in the current tax database a unique FILEID can be assigned with a version number (704, 705 and 706). All of these FILEIDs are also associated with the same tax return as different versions (709).

If the tax return originated from another database that is connected through a peer-to-peer connection the FILEID can indicate the original location as either an ODBC (711), JDBC (712) or Http connection (713).

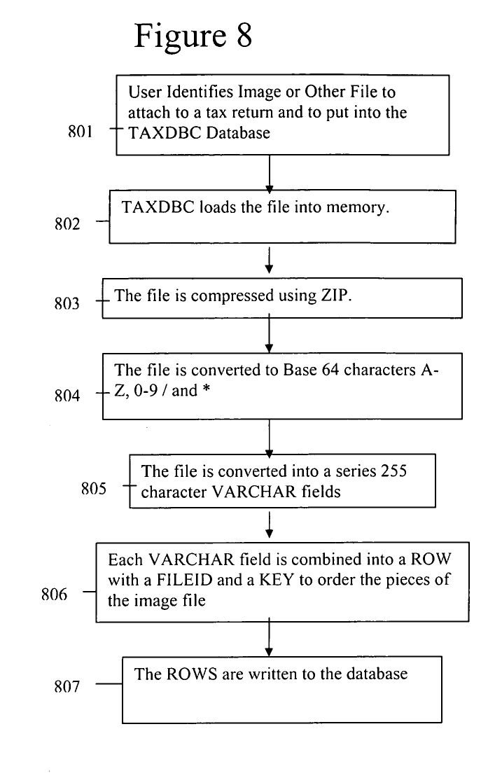

Sometimes users need to store images, spreadsheets and other types of files (attachments) with a tax return. But, since each database may have a different format for storing images and other types of files the TAXDBC needs to convert the images into a standard format so that the attachments can be moved and recovered between all of the different types of databases. This is shown in FIG. 8. In 801 the user identifies the attachment. Then in 802 the TAXDBC loads the attachment file into memory. Next in 803 the file is compress using ZIP or other compression method. Then the file can optionally be encrypted and then converted into Base 64 characters (804). This is done since Base 64 characters are supported on all standard databases. Then the file is converted in a series of 255 character VARCHAR fields (805). This is done since all standard databases can support 255 character VARCHAR fields. Then ROWS are built with a FILEID and KEY (806). This allows the attachment to be identified with a particular tax return and allows ordering of the rows for later reconstruction of the attachment. Finally, the ROWS are written to the database (807).

Many additional functions can be provided by the TAXDBC connector based on this method:

SAVE to Disk—All rows with a selected FILEID in the database are selected into a single ROWSET and put into a text file with or without encryption and put on a removable media for later retrieval later.

LOAD from Disk—The ROWSET previously stored is copied from the removable media either with or without encryption and put back into the database as per the UPDATEINSERT procedure.

Export Database—All rows from all tables in the database are selected into a single ROWSET and put into a text file with or without encryption and put on a removable media for retrieval later.

Import Database—All rows from a data file are added to a current database using the UPDATEINSERT procedure above.

Check Out—This allows a user to get a version controlled copy of a tax return for editing. No editing can be done until the user exclusively checks out a tax return. To check out a tax return all rows with a given FILEID are selected from the database that represents the tax return and a new FILEID is assigned to the tax return. The old FILEID is used but a version number is appended the old FILEID.

Check In—This allows other users to edit the tax return. The tax return is released by the current user and can not be edited again until the tax return is checked out again.

View audit log—This shows the user a list of all versions of a given tax return, including the USER and date the version was last modified. Then a old version of the tax return can be viewed or edited.

Search—This will search for specific information in a tax return and list the FILEID of the selected returns and other information such as the name of the tax return and user who is currently editing the tax return.

New—This will create a new tax return. A new FILEID is assigned to the new tax return.

Edit—This will check out a tax return and allow the user to edit the tax return if the tax return has not been checked out by another user.

View—This will allow a user to view but not edit a tax return that has been checked out by another user.

Pay—This will allow the user to pay for the software to access the tax return. There can be a charge per tax return that the TAXDBC system is holding in the database. The user may have limited access until the tax return is paid for. For example, the user may not be allowed to EFILE to PRINT the tax return until the tax return has been paid for.

Delete—This will mark a given FILEID as deleted. The rows will still be in the database for later recovery. But each row is marked as deleted. It can then be actually deleted later.

Copy—This make a duplicate of a tax return for separate editing. A new FILEID is generated and all rows with the old FILEID are selected and then the UPDATEINSERT method is used to duplicate the tax return.

PRINT ALL—This selects all rows in the database for a given FILEID. The data is then used to populate the printed tax return such as a Adobe Acrobat PDF or Microsoft Word file. This file can then be printed a local printer or saved for later use.

Add Attachment. This allows other data to be stored with the tax return. Any file on the local computer system can be selected for storage such as a scanned image or spreadsheet. Since the local database may or may not provide for storage of that type of file the TAXDBC must convert the file to a standard VARCHAR 255 character base 64 encoding with or without compression such as ZIP and a MIME header for the file type that all databases can support for storage of the images or other types of data.

Show Attachments—This shows a list of attachments stored in the database and allows the user to select an attachment from the database. The attachment is then saved into its original. format and encoding. The attachment can then be displayed using a viewer selected based on the MIME header.

EFILE—This selects all rows for a given FILEID and sends the data to the central taxing authority such as the United States IRS with any electronic payment or refund information that may be due. By using the standard columns that match with the EFILE sequence numbers, line codes or XML element data the information can be easily converted to the format required by the taxing authority.

The advantages of the TAXDBC include:

(a) All returns prepared by the same company can be stored in the same database. This allows all users from the same company to access and share the data.

(b) Industry standard databases can be used to store the data.

(c) No other user of the tax web site can access another company's data.

(d) The site is more scalable since each company has their own database the central web site does not require a more and larger database to accommodate more users.

(e) By using mobile JAVA applets and Microsoft .NET Browser controls a wide variety of user operating systems can be supported.

(f) Each user has the latest version of the code at all times

(g) Version control is provided on the tax returns, so older versions of the tax return can be recovered by the users.

(h) Users can easily change and share between database vendors. Since the TAXDBC automatically handles a wide variety of databases. All conversion of data is automatic as per the procedures above.

(i) Only one code base for all tax forms is required. Since the TAXDBC handles the differences between the data base vendor formats, only one version of the tax and accounting software applets is required for a database version.

(j) Images can be stored with tax return data.

### CONCLUSION

The above specification, examples, and data provide a complete description of the manufacture and use of certain embodiments of the invention. Since many embodiments of the invention can be made without departing from the spirit and scope of the invention, the invention resides in the claims hereinafter appended.

It should be understood that various alternatives and modifications of the present invention can be devised by those skilled in the art. The present invention is intended to embrace all such alternatives, modifications and variances that fall within the scope of the appended claims.

1. A method to use peer-to-peer connections to prepare a tax return by:
i) downloading mobile code from one or more web servers;
ii) said mobile code provides a client software interface (TAXSOFTWARE) to input and edit tax return information;
iii) said mobile code provides database server software (TAXDBC) interface means to allow one or more users to connect to one or more databases at various locations on the network, intranet or internet to save tax return information;
iv) said users may run either the client mobile code (TAXSOFTWARE) or server mobile code (TAXDBC) or both on each computer.

2. The system of claim 1 where the mobile code is written in JAVA.

3. The system of claim 2 where the mobile code is written with JAVA applets.

4. The system of claim 1 where the mobile code is written in Microsoft .NET J# browser controls.

5. The system of claim 1 where the mobile code is written in Microsoft .NET.

6. The system of claim 1 where the mobile code is written in C++.

7. The system of claim 1 where the databases are heterogeneous and of different manufacture and the TAXDBC handles all of the SQL syntax translation required.

8. The system of claim 1 where clients are running different operating systems and the web server needs to provide the appropriate mobile code for each client.

9. The system of claim 1 where the server mobile code automatically creates on demand the schema or part of the schema in the database as the client mobile code saves data to the database.

10. The system of claim 9 where the client mobile codes provide a list of columns and values to be UPDATEd or INSERTed into the database prior to updating the row, and the TAXDBC inspects the table prior to the INSERT or UPDATE and creates any missing columns.

11. The system of claim 10 where the column names include a code to indicate the column type so that, when it creates the columns, the TAXDBC can create the correct type of column in the database.

12. The system of claim 1 where the mobile code provides version control and access to previous versions of the tax return.

13. The system of claim 1 where the mobile code allows the user to store images and other files with the tax return for later retrieval by the same or other users.

14. The system of claim 1 where a method is used to identify where to store the data in the tax return and each tax form is represented by one table in the database and unique FILEID is assigned to each tax return and a unique KEY is assigned to each occurrence of a form in the tax return.

15. The system of claim 1 where the database does not permit enough columns to hold the data for a single form in a single row in a single table; then a series of two or more tables are created to simulate a single table and hold the form data.

16. The system of claim 1 where the database connection from the TAXDBC to the database uses JDBC.

17. The system of claim 1 where the database connection from the TAXDBC to the database uses ODBC.

18. The system of claim 1 where the JDBC or ODBC connection can not be made due to firewall security restrictions, then in this case the TAXDBC uses a HTTP protocol connection to transfer data to and from the database which is permitted by most firewall configurations.

19. A method to use peer-to-peer connections to share data by:
i) downloading mobile code from one or more web servers;
ii) said mobile code provides a client software interface to input and edit data;
iii) said mobile code provides a database server software interface means to allow one or more users to connect to one or more databases at various locations on the network, intranet or internet to save data;
iv) said users may run either the client mobile code or the server mobile code or both on each computer.

20. The system of claim 19 where the mobile code is written in JAVA.

21. The system of claim 20 where the mobile code is written in JAVA applets.

22. The system of claim 19 where the mobile code is written in Microsoft .NET.

23. The system of claim 19 where the mobile code is written in C++.

24. The system of claim 19 where the databases are heterogeneous and of different manufacture and the TAXDBC handles all of the SQL syntax translation required.

25. The system of claim 19 where clients are running different operating systems and the web server needs to provide the appropriate mobile code for each client.

26. The system of claim 19 where the server mobile code automatically creates on demand the schema or part of the schema in the database as the client mobile code saves data to the database.

27. The system of claim 26 where the client mobile codes provide a list of columns and values to be UPDATEd or INSERTed into the database prior to updating the row; and the TAXDBC then inspects the table prior to the INSERT or UPDATE and creates any missing columns.

28. The system of claim 25 where the column names include a code to indicate the column type so that, when it creates the columns, the TAXDBC can create the correct type of column in the database.

29. The system of claim 19 where the mobile code provides version control and access to previous versions of the tax return.

30. The system of claim 19 where the mobile code allows the user to store images and other files with the tax return for later retrieval by the same or other users.

31. The system of claim 19 where a method is used to identify where to store the data in the tax return where each tax form is represented by one table in the database and unique FILEID is assigned to each tax return and a unique KEY is assigned to each occurrence of a form in the tax return.

32. The system of claim 19 where the database does not permit enough columns to hold the data for a single form in a single row in a single table; then a series of two or more tables are created to simulate a single table and hold the form data.

33. The system of claim 19 where the database connection from the TAXDBC to the database uses JDBC.

34. The system of claim 19 where the database connection from the TAXDBC to the database used ODBC.

35. The system of claim 19 where the JDBC or ODBC connection can not be made due to firewall security restrictions, in this case the TAXDBC uses a HTTP protocol connection to transfer data to and from the database which is permitted by most firewall configurations.

36. A system of automatically monitoring SQL as it sent to the database and determining if a table or column is missing and then on demand altering the database schema to accommodate said table or column prior to an INSERT or UPDATE SQL statement.
